(19) United States
(12) Patent Application Publication
(10) Pub. No.: US 2017/0239500 A1
(43) Pub. Date: Aug. 24, 2017

(54) FIRE BARRIER INSERT FOR MEMBRANE PENETRATIONS

(71) Applicant: Fire Shield LLC, Las Vegas, NV (US)

(72) Inventor: James N. Koehler, Henderson, NV (US)

(21) Appl. No.: 15/439,716

(22) Filed: Feb. 22, 2017

Related U.S. Application Data
(60) Provisional application No. 62/299,435, filed on Feb. 24, 2016.

(51) Int. Cl. A62C 2/06; E04B 1/94

(52) U.S. Cl. CPC A62C 2/06; E04B 1/947

(57) ABSTRACT

A fire barrier insert for placement within a framed out membrane penetration in a fire barrier wall is constructed of a central back member of a high-temperature drywall board and an attached flexible intumescent mat. The central back board is configured for placement against a drywall panel of similar configuration within the framed out membrane penetration. The flexible intumescent mat consists of separate panels, each attached to the central back board for extending along the frame members and to the outer edge of the framed out membrane penetration. A fixture cabinet is placed within the framed out membrane penetration after installation of the fire barrier insert.

### RELATED APPLICATIONS

The present application claims the benefit of priority under 35 USC §119(e) to U.S. Provisional Application No. 62/299,435 filed on Feb. 24, 2016, which is incorporated by reference herein for all that it contains.

### BACKGROUND OF THE INVENTION

Field of the Invention

The present invention relates to thermal barriers and, more particularly, to fire resisting thermal barriers. More specifically, the present invention relates to fire barrier inserts placed within framed out recessed fixture membrane penetrations in a fire barrier wall.

Description of the Related Art

Part of the passive fire protection system for a building, a fire barrier wall is intended to prevent or delay the spread of fire. Building codes require the interior walls and ceilings of commercial buildings provide a specified fire-resistance rating, depending upon their location and the nature of their use within the commercial structure. Fire ratings are often specified based upon duration (for example a 1-hour minimum resistance) under standardized test conditions.

Most commercial buildings have recessed fixtures spaced along the corridors, such as fire extinguisher cabinets, fire hose cabinets, electrical panels, wall safes, eye wash stations, utility controllers, dryer vent boxes, shower valves, plumbing feeds, and speaker boxes. At such locations, a breach occurs in the fire-resistant material, termed a “membrane penetration.” Building codes require that upon completion, the wall or corridor must comply with the required fire-resistance rating. Any breaches resulting from installation of recessed fixtures cannot reduce the fire rating required of the wall or partition.

One method used to comply with such Code requirements is to protect the fixture prior to its installation, such as by wrapping the fixture in a tested and listed fire blanket or mat (such as 3M™ Interam™ Endothermic Mat E-5A-4, 3M Fire

Protection Products, www.3m.com/firestop). Installation of electrical panels is often in this manner. As a downside, the pre-installation wrapping (or other manner of protection) risks damaging the fixture or the cabinet into which it is installed. When the protection is added off-site, there is the added risk of damage during shipment of the protected fixture to the job site.

Pre-built, fire-rated enclosures are provided for fixtures not normally offered in cabinets, such as speakers, and plumbing valves. Fire-rated enclosures offered by such companies as FRPS Corp of Minneapolis, Minn. (www.frpsonline.com), are installed in the wall prior to installation of the fixture.

Many contractors would prefer to fabricate a fire-rated enclosure on site and avoid problems associated with the early purchasing and storage of the pre-built enclosures. The International Building Code (Section 713.3.2, Exception #4) allows such construction for other than electrical boxes. The constructed box must be installed with an approved membrane penetration firestop system, and the firestop system must be used and installed as tested under an approved procedure (ASTM E 814 or UL 1479). Examples of the fixtures for such boxes or cabinets would include (but not be limited to) Fire extinguishers, fire hoses, electrical panels, time clocks, wall safes, med-gas boxes, shower valves, dryer exhausts, and eye wash stations.

Though un-approved, “five-siding” is a commonly-used example of such on-site constructions. The framing contractor frames an opening lined with gypsum board on the top, sides, bottom, and (sometimes) back. The variance in framing design and quality of construction makes such “five-siding” problematic from an inspection perspective. Framers often omit the back section of gypsum board, leaving an opening in the fire barrier wall that offers no resistance to the spread of fire.

The installer may not understand the fire-resistant function of the required enclosure and how its modification may affect performance of the membrane penetration assembly during a standardized fire test, as required by the Code. The “five-siding” practice ignores the Code requirements, and a need exists to provide contractors with a reliable on-site box construction for insuring fire rating Code compliance for membrane penetrations.

### SUMMARY OF THE INVENTION

The present invention provides a fire barrier membrane insert construction, which, when installed within the membrane penetration opening, fire-protects the membrane penetration. With the opening protected and the fire-resistance of the wall or ceiling kept, installation of the fixture no longer needs addressing specific fire barrier issues-whether wrapping the fixture prior to installation or first installing a fire-rated box. The present invention enables installation of the fixture to continue without regard to fire barrier concerns.

The materials used to construct the fire barrier insert of the present invention are sufficiently thin that once installed, the later installation of fixture cabinets can follow the framing guidelines issued to cabinet installers without regard to the installed fire barrier insert.

Installation of the fire barrier insert under the present invention results in a fire barrier construction easily inspected during construction. If included during the framing inspection, the cost (and delay) of a subsequent inspection would be avoided. This contrasts with pre-protected fixtures, such as pre-installation wrapping, where it is not possible to visually verify that the item is protected once installed.

An aspect of embodiments in accordance with the present invention is a fire barrier insert configured for receipt within a framed out membrane penetration in a fire barrier wall, comprising: A central back board, wherein said central back board is a high-temperature drywall board, and wherein an outer periphery of said central back board defines a configuration of matching relation to the configuration of the framed out membrane penetration in said fire barrier wall; and a flexible intumescent mat attached to and extending from said central back board at, and circumferentially about, said outer periphery.

Another aspect of embodiments in accordance with the present invention is a fire barrier insert comprising: A central back board is configured for abutting and lying against, in matching configuration, a drywall panel in a framed out membrane penetration in a fire barrier wall; and a flexible intumescent mat comprising a top panel, a bottom panel, and a pair of side panels, wherein each of said panels is attached to an outer periphery of said central back board along a separate length thereof, and wherein each of said panels is configured for extending from each respective attachment location on said central back board to an opening edge of the framed out membrane penetration in the fire barrier wall.

A still further aspect of embodiments in accordance with the present invention is a fire barrier insert comprising: A central back board for being received by and against a drywall panel of matching configuration located within a framed out opening of a membrane penetration in a fire barrier wall; and a flexible intumescent mat attached to said central back board for extending along the frame members of the framed out opening and to the outer edge of the membrane penetration.

The invention is not limited in its application to the details of construction and the arrangement of components described hereinafter and illustrated in the drawing figures. Those skilled in the art will recognize that various modifications can be made without departing from the scope of the invention.

These and other objects, aspects, and features of the present invention will be better understood from the following description of embodiments when read in conjunction with the appended drawing figures.

### BRIEF DESCRIPTION OF THE DRAWINGS

Embodiments in accordance with the present invention are described below in connection with the accompanying drawing sheets.

FIG. 1 is a perspective view, with portions shown in phantom, of a fire barrier insert prior to installation within a framed out opening/membrane penetration in a fire barrier wall in accordance with the present invention.

FIG. 2 is a partial perspective view of a fire barrier insert installed within the framed out opening in a fire barrier wall with a fire extinguisher cabinet positioned for installation within a protected membrane penetration in accordance with the present invention.

FIG. 3A is a perspective view of a deconstructed fire barrier insert with component members arranged in proximity to their respective, attached locations to a central board in accordance with the present invention.

FIG. 3B is perspective view, similar to FIG. 3A, showing an assembled fire barrier insert in accordance with the present invention.

FIG. 4A is a perspective view, partially exploded and with portions in phantom, deconstructed in a similar manner as in FIG. 3A showing an alternative embodiment of a fire barrier insert in accordance with the present invention.

FIG. 4B is a perspective view, similar to FIG. 4A, showing an assembled alternate embodiment of a fire barrier insert in accordance with the present invention.

### DETAILED DESCRIPTION OF THE PREFERRED EMBODIMENTS

The fire barrier insert for membrane penetrations is disclosed herein with respect to exemplary embodiments. The embodiments are disclosed for illustration of the fire barrier insert for membrane penetrations and a manner of making use of such insert, and are not limiting except as defined in the appended claims.

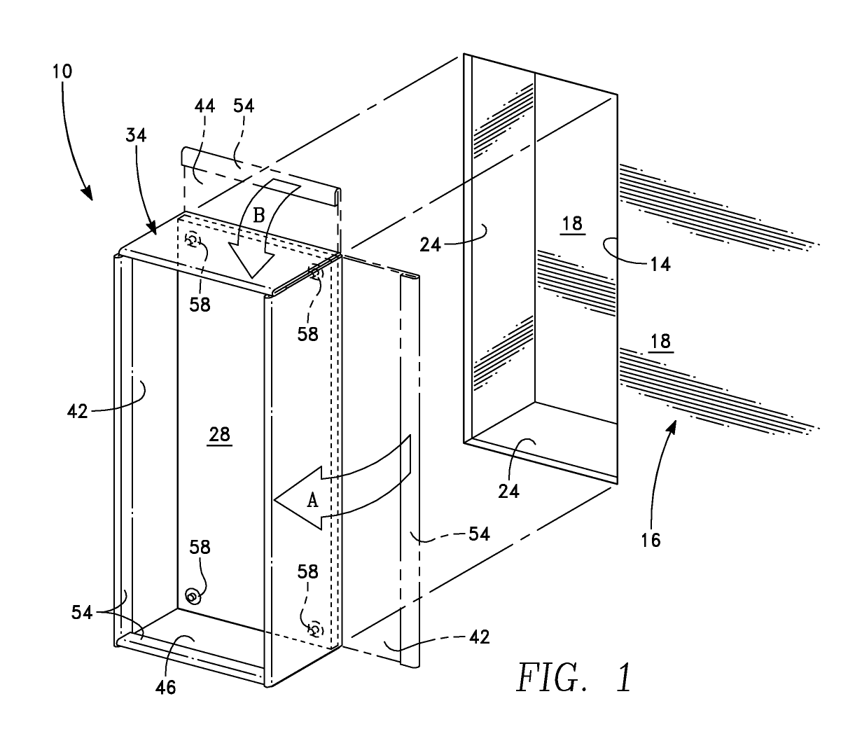

Reference is now made to the drawings wherein like structures refer to like parts throughout. In FIG. 1, a fire barrier insert 10 is shown positioned adjacent a membrane penetration 14 in a fire barrier wall 16—typically constructed using a plurality of drywall panels 18 attached to a framework of either metal or wood studs 24.

The fire barrier insert 10 includes a central back board 28 and a flexible mat 34 extending outwardly from the top, bottom, and lateral sides of the central back board 28. In a presently preferred embodiment, the flexible mat 34 consists of a pair of extending side panels 42, a top panel 44, and a bottom panel 46, with each provided a thickened front edge 54. A plurality of insulation fasteners 58 attach the flexible mat 34 to the central back board 28.

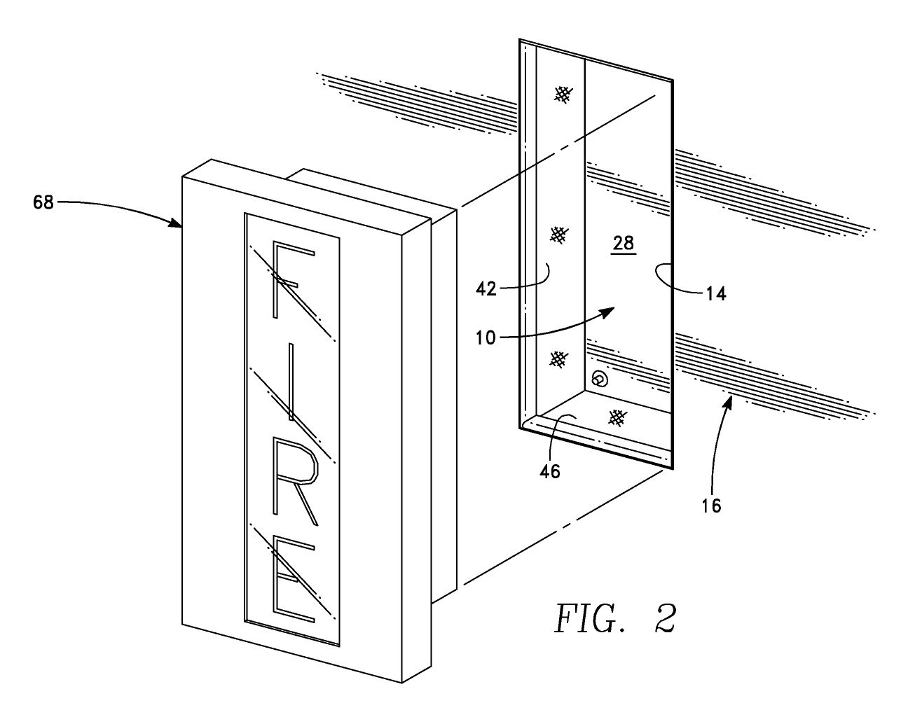

Upon insertion into the membrane penetration 14, the fire barrier insert 10 obtains a box-like configuration, each of the side panels 42 folding inwardly, as depicted by Arrow A, and the top and bottom panels 44, 46 folding inwardly, as depicted by Arrow B. In FIG. 2 the fire barrier insert is shown received within the membrane penetration 14, with a fixture cabinet 68 shown positioned prior to mounting and installation within the membrane penetration 14 in the fire barrier wall 16.

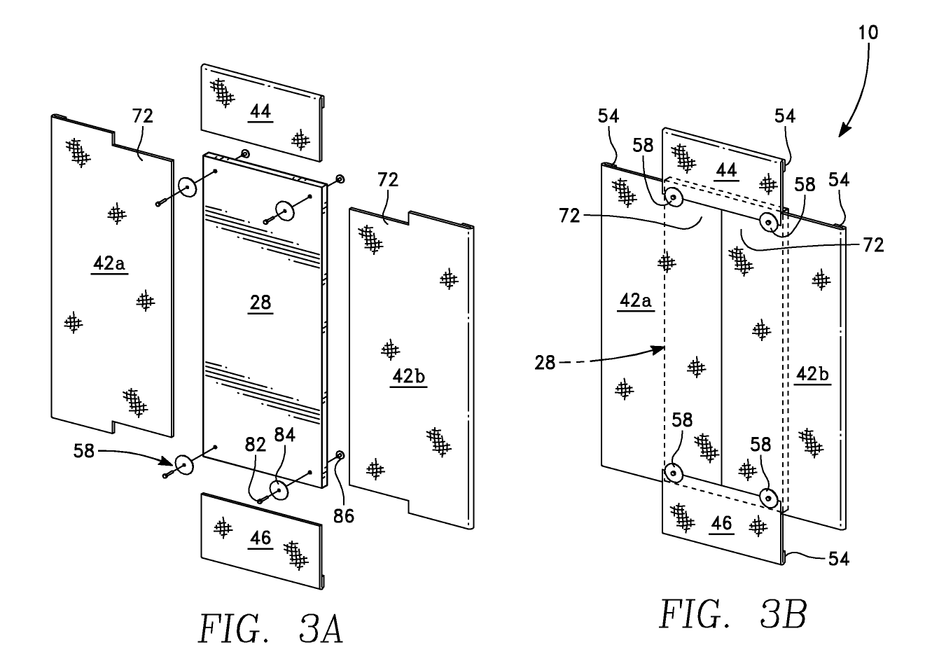

A presently preferred manner of assembling the fire barrier insert 10 is shown in FIGS. 3A and 3B. The central back board 28 is placed between the pair of side panels 42a, 42b, the top panel 44 and the bottom panel 46. Each of the side panels 42a, 42b, includes a nose extension 72 of reduced width and of appropriate length that each extend over and are received by one-half the width of the central back board 28.

The reduced width of the nose extensions 72 results in an uncovered top and bottom strip on the surface of the central back board 28 to receive an edge of the top and bottom panels 44, 46. An appropriate adhesive is preferably used to adhere the nose extensions 72 and the edges of the top and bottom panels 44, 46 to the surface of the central back board 28. The plurality of insulation fasteners 58 offer added security, with one of the insulation fasteners 58 placed in each of the four corners of the central back board 28. Each of the insulation fasteners 58 preferably consist of a securement screw 82, an enlarged insulation washer 84, and a base nut 86.

The thickened front edges 54 of the embodiment shown in FIGS. 3A and 3B are each provided by a doubling obtained upon folding over the leading outer edges of both the side panels 42a, 42b, and the top and bottom panels 44, 46. An appropriate adhesive is preferably used to secure the thickened front edges 54 in the folded-over position.

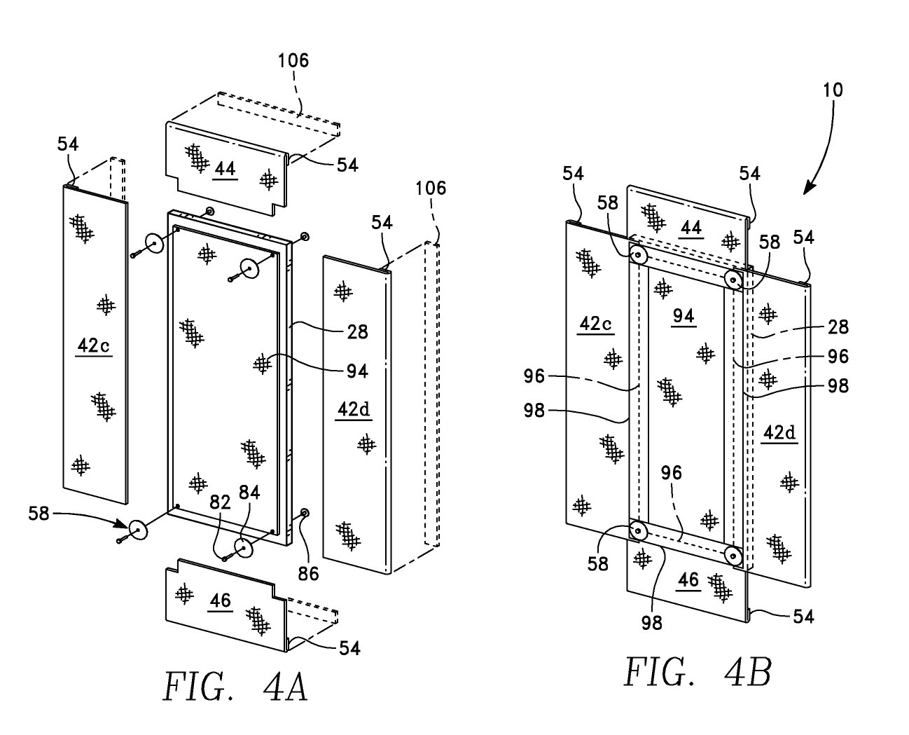

A presently preferred alternative manner of assembling the fire barrier insert 10 is shown in FIGS. 4A and 4B. The central back board 28 is placed between the pair of rectangular side panels 42c, 42d, the top panel 44 and the bottom panel 46. A mat backing 94 is attached to the surface of the back board 28 with an appropriate adhesive.

The outer edges of the mat backing 94 are preferably spaced from the peripheral edges of the central back board, offering an attachment surface for the top, bottom and side panels 42c, 42d, 44, 46. An edge of each of the panels, sides, top and bottom, attach to laterally adjacent strips on the surface of the central back board 28 using an appropriate adhesive.

Such panel and backboard placement forms a plurality of abutting joints 96, which are preferably reinforced using a plurality of strips of insulation tape 98, each positioned and applied to overlie one of the plurality of abutting joints 96. A plurality of the insulation fasteners 58 complete the securement, one of the insulation fasteners 58 placed in each corner of the central back board 28.

FIGS. 4A and 4B also illustrate an alternative manner of forming the thickened front edge 54. A plurality of flexible mat strips 106 are adhesively attached, each to a separate front edge of one of the side, top, and bottom panels 42a, 42b, 44, 46 using an appropriate adhesive.

The fire barrier insert of the present invention is preferably fabricated using a central back high-temperature gypsum board with an intumescent mat used to fabricate the periphery. An acceptable high-temperature drywall board for use in the present invention is Flame Curb® ½-inch Super C Board, manufactured by PABCO® Gypsum of Rancho Cordova, Calif. (www.pabcogypsum.com). The gypsum board is cut to size, which will typically be ½-inch smaller than the size of the rough opening in the fire barrier wall as recommended by the cabinet manufacturer. Preferably, a coat of water-based latex paint is applied to the exposed side of the gypsum board (the exposed side faces the front of the fire barrier wall). Such paint enhances the durability of the board, protecting the surface from damage during shipping and handling.

The intumescent mat is preferably 3/16 inch in thickness for the side, top, and bottom panel pieces. In the alternative embodiment, an intumescent mat of 1/16-inch thickness is laminated onto the back of the gypsum board. A presently preferred mat is I-10 Mat manufactured by 3M® Company, Minneapolis, Minn. (www.3m.com). The side panel mats are sized to be the same length as that of the gypsum board. The width of each strip is enough to inwardly fold as the fire barrier insert is installed within the membrane penetration. This allows the flexible mat to center the fire barrier insert within the opening. Under a fire condition, the intumescent mat expands and seals the gypsum board and framing interface.

In a presently preferred embodiment, the edges of the two 3/16-inch intumescent mat side panel pieces each extend half-way across the back of the gypsum board, the edges forming an abutting joint along the central longitudinal axis of the gypsum board. Alternatively, the edges of the 3/16-inch intumescent mat side panel pieces are attached to the outer edges of the back of the gypsum board, overlapping by approximately ¾ inch. In either embodiment, attachment to the board is preferably with an adhesive such as 3M® Super 77® or Super 90 spray adhesives, manufactured by 3M® Company.

In the alternative embodiment depicted in FIGS. 4A and 4B, an added 1/16-inch intumescent mat is attached to the back of the gypsum board, extending between the side panel pieces attached to the gypsum board edges. Foil tape covers the abutting joints, or seams, where the back intumescent mat meets each side panel mat. A suitable foil tape is 3M® FSK Facing Tape 3320, manufactured by 3M Company. The four insulation fasteners each consist of a screw, an insulation washer, and a receptacle nut, the screw extending through the back of the gypsum board and into the receptacle nut (see FIGS. 3 and 4). The insulation fasteners further secure the 3/16-inch intumescent mat to the gypsum board.

A presently preferred manner of utilizing the fire barrier insert of the present invention when installing a fire extinguisher cabinet in a fire barrier wall is described below. The steps named and details shown about such installation are provided by way of example and not limitation.

An opening in the fire barrier wall is formed and framed following the guidelines of the cabinet manufacturer, such as fire extinguisher cabinet Model 2409, manufactured by Larsen Manufacturing Company of Minneapolis, Minn. (www.larsenmfg.com). Cabinet Model 2409 has outer dimensions of 24 inches by 9½ inches. Use of the present fire barrier insert requires a nominal one inch larger frame out opening size in the fire barrier wall. In this example, an appropriate frame out opening measures 25 inches in height, 10½ inches in width, and 3⅝ inches in depth.

Assembly of a fire barrier insert of appropriate size begins with formation of the central back board, cut from a high-temperature gypsum board to measure 24½ inches by 10 inches. Four 3/16-inch holes are drilled into the board, one hole in each of the four corners, one inch from the corner edges. A water-based acrylic paint is applied to the face (front) side and the four board edges. An appropriate paint is Pro Industrial™ Multi-Surface Acrylic paint sold by Sherwin-Williams (www.sherwin-williams.com).

The two side panels are each cut from 3/16-inch thick I-10 Mat, with a foil layer on one side, to a size of 11¼-inches by 24½ inches. Where forming the thickened front edge by folding the front edges, on the non-foil side, route a groove ⅛-inch deep and 1 inch from the front edge. Using 3M® Super 90 spray adhesive, on the non-foil side, spray a two-inch-wide band along the front edge the length of the mat panel. Fold over the front edge of the mat at the groove, creating a doubling along the front edge. Attach the non-folded edge and adjacent five inches of the non-foil side to the central back board by applying the Super 90 spray adhesive to a five-inch-wide band running the length of the mat and attaching it to the non-painted rear side of the central back board along each of the lateral sides.

A top and a bottom panel are each cut from 3/16-inch thick I-10 Mat, with a foil layer on one side, to a size of 6¼ inches by 10 inches. Where forming the thickened front edge by folding the front edges, on the non-foil side, route a groove ⅛-inch deep and 1 inch from the front edge. Using 3M® Super 90 spray adhesive, on the non-foil side, spray a two-inch-wide band along the front edge the length of each mat panel. Fold over the front edge of the mat at the groove, creating a doubling along the front edge. Attach the non-folded edge and adjacent one inch of the non-foil side to the central back board by applying the Super 90 spray adhesive to a one inch-wide band running the length of the mat and attaching it to the non-painted rear side of the central back board along the top and bottom sides.

Attachment of the insulation fasteners completes fabrication of the fire membrane insert. The screws, each with an insulation washer, extend from the back side, through the 3/16-inch corner holes in the central back board. The base nuts are positioned adjacent the corner holes on the front side of the central back board and receive the screws, tightening to complete the fastener.

The assembled fire barrier insert is placed adjacent to the framed opening. Installation consists of pushing the fire barrier insert into the opening, with the central back board forming the back side of the opening. Upon pressing in at the corners, the intumescent mat edges fold along their attachment to the central back board, conforming to the inside corners of the framed opening. When the fire barrier insert is fully received within the opening, the sides, top, and bottom mat panel edges extend along and fully overlap the peripheral interface between the central back board and the framing stud.

Installation of the fire barrier insert within the opening is completed by placing a ¼-inch diameter bead of caulking into the four inside corners of the installed barrier insert, and a ¼-inch bead of caulking around the outer perimeter to seal between the cut edges of the outer gypsum drywall and the front edges of the fire barrier insert seated within the opening. Where desired, wafer head screws may be installed through the mat panels to help keep the fully inserted position of the fire barrier insert within the opening while awaiting cabinet installation.

Where the fixture cabinet includes penetrations, installation proceeds as above, through securing the cabinet within the opening, taking care to center the cabinet using the cabinet fasteners, to insure proper seating of the outer cabinet cover onto the finished wall. An aperture is cut through the web panel insert at the location and of the size appropriate for the cabinet to accept the penetrant(s) and connection(s). A ½-inch bead of caulking is installed at the penetrant-insert interface, with an additional ½-inch of caulking or putty placed adjacent the penetrant cabinet entry location, inside the cabinet.

Should a fire occur within the space protected by the fire barrier wall, the fire barrier insert within the membrane penetration maintains the rating protection of the fire barrier wall-with the wall protected from fire on both sides.

On the “room side” of the wall, the fire extinguisher cabinet will be exposed to the fire. The heat will travel into the metal cabinet, seeking to transfer heat to the back side of the next-adjacent wall. The heat transferred to the cabinet will be stopped by the exposed central back gypsum board of the fire barrier insert, which is located immediately behind the metal cabinet. The I-10 Mat located to the sides of the metal cabinet will expand upon exposure to heat, and seal the gap between the central back gypsum board and the framing of the opening. Both features of the fire barrier insert contain the heat, which would otherwise degrade the drywall on the opposite/far side of the fire barrier wall.

On the “back side” of the wall (the side of the wall without the membrane penetration), a fire burning through the gypsum would heat the fire extinguisher cabinet, degrading the drywall into which the cabinet is mounted, failing the test requirements. With the fire barrier insert installed within the opening-prior to cabinet installation, the central back gypsum board of the fire barrier insert impairs heat transfer to the fire extinguisher cabinet. The 3/16-inch intumescent I-10 Mat will expand upon heating to seal any gaps around the central back gypsum board and between the metal cabinet and the framed opening.

As various changes could be made in the above constructions without departing from the scope of the invention, it is intended that all the matter contained in the above description or shown in the accompanying drawings shall be interpreted as illustrative and not in a limiting sense.

What is claimed is:

1. A fire barrier insert configured for receipt within a framed out membrane penetration in a fire barrier wall, comprising:
a central back board, wherein said central back board is a high-temperature drywall board, and wherein an outer periphery of said central back board defines a configuration of matching relation to the configuration of the framed out membrane penetration in said fire barrier wall; and
a flexible intumescent mat attached to and extending from said central back board at, and circumferentially about, said outer periphery.

2. The fire barrier insert of claim 1, wherein said flexible intumescent mat has a thickened front edge.

3. The fire barrier insert of claim 2, wherein said central back board is rectangular and said outer periphery comprises a top side, a bottom side, and a pair of lateral sides.

4. The fire barrier insert of claim 3, wherein said flexible intumescent mat comprises a top panel, a bottom panel, and a pair of side panels, and wherein said top panel is attached to said top side of said central back board, said bottom panel is attached to said bottom side of said central back board, and each of said pair of side panels is attached to a separate one of said pair of lateral sides of said central back board.

5. A fire barrier insert comprising:
a central back board is configured for abutting and lying against, in matching configuration, a drywall panel in a framed out membrane penetration in a fire barrier wall; and
a flexible intumescent mat comprising a top panel, a bottom panel, and a pair of side panels, wherein each of said panels is attached to an outer periphery of said central back board along a separate length thereof, and wherein each of said panels is configured for extending from each respective attachment location on said central back board to an opening edge of the framed out membrane penetration in the fire barrier wall.

6. The fire barrier insert of claim 5, wherein each of said top panel, said bottom panel, and said pair of side panels has a thickened front edge.

7. The fire barrier insert of claim 6, wherein said thickened front edge is a doubled edge.

8. The fire barrier insert of claim 7, wherein each of said top panel, said bottom panel, and said pair of side panels has a folded-over front edge.

9. The fire barrier insert of claim 7, wherein each of said top panel, said bottom panel, and said pair of side panels has a separate strip of said flexible intumescent mat of narrow width and matching length attached to the front edge.

10. The fire barrier insert of claim 6, wherein said central back board is rectangular.

11. A fire barrier insert comprising:
a central back board for being received by and against a drywall panel of matching configuration located within a framed out opening of a membrane penetration in a fire barrier wall; and
a flexible intumescent mat attached to said central back board for extending along the frame members of the framed out opening and to the outer edge of the membrane penetration.

12. The fire barrier insert of claim 11, wherein said central back board is a high-temperature drywall board and wherein said flexible intumescent mat has a thickened front edge.

13. The fire barrier insert of claim 12, wherein said flexible intumescent mat comprises a plurality of separate panels.

14. The fire barrier insert of claim 13, wherein said central back board is rectangular, and wherein said flexible intumescent mat comprises a top panel, a bottom panel, and a pair of side panels, and wherein said top panel is attached to said top side of said central back board, said bottom panel is attached to said bottom side of said central back board, and each of said pair of side panels is attached to a separate one of said pair of lateral sides of said central back board.
